(19) United States
(12) Patent Application Publication
(10) Pub. No.: US 2004/0164234 A1
(43) Pub. Date: Aug. 26, 2004

(54) Near field microscope including waveguide resonator

(76) Inventors: Kie Jin Lee, Seoul (KR); Joo Young Kim, Pajoo-city (KR); Myung Sik Kim, Kwangjoo-city (KR); Won Kyun Park, Seoul (KR)

Correspondence Address: FROMMER LAWRENCE & HAUG, 745 FIFTH AVENUE- 10TH FL., NEW YORK, NY, 10151, US

(21) Appl. No.: 10/781,481

(22) Filed: Feb. 18, 2004

(30) Foreign Application Priority Data
Feb. 20, 2003 (KR) 2003-10710

(51) Int. Cl. H01J 3/14; H01J 5/16

(52) U.S. Cl. 250/234

(57) ABSTRACT

A near field microscope which uses a wide frequency band by combining a probe with a waveguide resonator and has improved sensitivity and resolving power is provided. The near field microscope comprises a wave source, which emits a wave with a variable frequency, a waveguide resonator through which the wave emitted from the wave source propagates, a probe, which perforates an outer wall of the waveguide resonator and by which the wave that propagates through the waveguide resonator interacts with a sample, and a detector, which detects the wave that has interacted with the sample.

### BACKGROUND OF THE INVENTION

This application claims the priority of Korean Patent Application No. 2003-10710, filed on Feb. 20, 2003, in the Korean Intellectual Property Office, the disclosure of which is incorporated herein in its entirety by reference.

1. Field of the Invention

The present invention relates to a near field microscope, and more particularly, to a near field microscope in which a probe is inserted into a waveguide resonator, thereby improving sensitivity and resolving power and extending a usable frequency band.

2. Description of the Related Art

Optical microscopes used to measure a shape of a nanometer-sized fine sample use light for observing an object. Thus, due to a diffraction limit, there is a limited lateral resolution. In other words, due to the diffraction limit, an object having a dimension less than ½ of a wavelength of the light cannot be observed. In order to solve this problem, near field microscopes, which overcome the diffraction limit and measure optical characteristics of a material having dimensions much smaller than the wavelength of light, have been developed. In the near field microscopes, light that passes through an aperture with a width smaller than the wavelength of light is irradiated onto a sample, which is placed a distance less than the width of the aperture from the aperture so that the diffraction limit is overcome using the fact that diffraction does not occur in a near field located within a distance smaller than the wavelength of the light from the surface of the sample.

Research on non-contact and non-destructive microscopes using an evanescent field or near field effect have been carried out since scanning tunneling microscopes (STM) and atomic force microscopes (AFM) were realized. Because of the development of optical microscope technology, microscopic characteristics of objects are being measured by optical microscopes. Accordingly, a method of measuring the microscopic characteristics of a sample has been spotlighted as a new research field. As electronic components become more integrated, research into physical characteristics of a fine structure have become important. In particular, it is essential to develop new measuring equipment that overcomes the diffraction limit to further understand and measure the physical characteristics of a fine structure.

Experiments on a near field using microwaves were first carried out by Ash and Nicholls. Since then, microwave near field microscopes have been further developed and have been used in a variety of fields. A microwave near field image may be obtained using a coaxial cable resonator, a stripline resonator, or a waveguide slit.

FIG. 1 shows a conventional optical microscope using a coaxial cable resonator disclosed in “APPLIED PHYSICS LETTERS, VOLUME 75, NUMBER 20”.

In the near field optical microscope, a wave emitted from a microwave source 100 is transmitted through a coaxial cable resonator 103 to a sample 107 whose optical characteristics are to be measured by a probe 105 formed on an end of the coaxial resonator 103. The wave emitted from the probe 105 interacts with the sample 107 and is then fed into the coaxial cable resonator 103 via the probe 105. A microwave altered by an interaction with the sample 107 is detected by a diode detector 110. As such, the microscopic and optical characteristics of the sample can be measured. Reference numeral 102 denotes a directional coupler.

Due to a cut-off frequency of a coaxial cable structure, only an experiment in a microwave band can be carried out using the coaxial cable resonator 103. Thus, the resonance frequency of the near field microscope is limited to a specific frequency of a microwave band, limiting sensitivity. The coaxial cable resonator 103 includes a cylindrical internal conductor and an external conductor. In a structure comprising two conductors, an experiment should be performed using a transverse electromagnetic (TEM) wave. Accordingly, in order to obtain the optical characteristics of the sample, there are limitations in the types of waves used. In other words, when the wave interacts with the sample, there are modes in which the optical characteristics of the sample are much better revealed. Since only a TEM should be used in the coaxial cable resonator, only a narrow range of samples can be measured using the near field microscope using the coaxial cable resonator.

In addition, since a frequency of a microwave band whose wavelength is long is used in the coaxial cable resonator 103, and the length of the coaxial cable resonator 103 becomes longer. The coaxial cable resonator 103 shown in FIG. 1 has a length of about 2 m. The optical microscope using the coaxial cable resonator 103 has a very large volume. As such, problems arise in commercialization of an optical microscope having the above structure.

A near field microscope using a waveguide slit disclosed in “APPLIED PHYSICS LETTERS, VOLUME 77, NUMBER 1” is shown in FIG. 2. In the near field microscope, a slit 115 is formed on an end of a waveguide 113, a substrate 120, on which a sample 117 is placed, is disposed under the slit 115, and light is irradiated from a light source 122 disposed below the substrate 120. Reference numeral 123 denotes a shadow mask.

In the above structure, light irradiated from the light source 122 interacts with the sample 117 and is then fed into the waveguide 113 through the slit 115. Characteristics of light after the light interacts with the sample 117 is measured by a detector so that the shape and characteristics of the sample 117 can be measured. However, in this waveguide slit structure, since a wave passes through the slit and is widely dispersed, wave loss is large, and resolving power is lowered.

### SUMMARY OF THE INVENTION

The present invention provides a near field microscope with a small volume and excellent sensitivity and resolving power, which precisely measures optical characteristics of a sample.

The present invention also provides a near field microscope which extends the frequency range of a wave from microwave to millimeter-wave bands and extends the range of a sample whose optical characteristics can be measured using a TE mode and a TM mode.

The present invention also provides a near field microscope which varies the resonance frequency of a waveguide resonator such that characteristics of a variety of samples can be measured using one waveguide resonator, thereby reducing manufacturing costs.

According to an aspect of the present invention, there is provided a near field microscope, the near field microscope comprising a wave source, which emits a wave with a variable frequency; a waveguide resonator through which the wave emitted from the wave source propagates; a probe, which perforates an outer wall of the waveguide resonator and by which the wave that propagates through the waveguide resonator interacts with a sample; and a detector, which detects the wave that has interacted with the sample.

The near field microscope may further comprise a tuner, which is movably connected to one end of the waveguide resonator and adjusts a length of the waveguide resonator.

A portion of the probe inside the waveguide resonator may have a linear 10 Shape or a loop shape.

When H₀ is a maximum value of a magnetic field perforating the portion of the probe inside the waveguide resonator, p is a p-value in a TE_{10P} mode, zᵢ is a position of a front end of the portion of the probe inside the waveguide resonator, z_{f} is the position of a rear end of the portion of the probe inside the waveguide resonator and d is a length of the waveguide resonator, a magnitude of an electromotive force generated in the probe is given by:

$$V = - \frac{{μ}_{0} j ω {ayH}_{0}}{π} [ 2 cos \frac{1}{2} \{ \frac{p π}{d} ( {z}_{f} + {z}_{i} ) \} sin \frac{1}{2} \{ \frac{p π}{d} ( {z}_{f} - {z}_{i} ) \} ] .$$

The probe may be disposed in a position that satisfies z_{f}=3d/2p, zᵢ=d/2p.

A slit may be formed in the waveguide resonator, and the probe may be movable along the slit.

The wave source may emit microwaves or millimeter-waves.

When a wavelength of the wave emitted from the wave source is λ, the length of the waveguide resonator may change by λ/4 increments.

### BRIEF DESCRIPTION OF THE DRAWINGS

The above aspects and advantages of the present invention will become more apparent by describing in detail exemplary embodiments thereof with reference to the attached drawings in which:

FIG. 1 shows a conventional near field microscope using a coaxial cable resonator;

FIG. 2 shows a conventional near field microscope using a waveguide in which a slit is formed;

FIG. 3 shows a near field microscope using a waveguide resonator according to an embodiment of the present invention;

FIG. 4A is a perspective view of the waveguide resonator of FIG. 3;

FIG. 4B is a cross-sectional view taken along a line IV-IV of FIG. 4A;

FIG. 4C shows a hybrid probe inserted into the waveguide resonator used in the near field microscope of FIG. 3;

FIG. 5 is a cross-sectional view of another example of a magnetic probe inserted into the waveguide resonator used in the near field microscope of FIG. 3;

FIG. 6A is a perspective view of still another example of a waveguide resonator used in the near field microscope;

FIG. 6B is a cross-sectional view taken along a line VI-VI of FIG. 6A; and

FIG. 7 is a cross-sectional view of a magnetic probe inserted into the waveguide resonator of FIG. 6A.

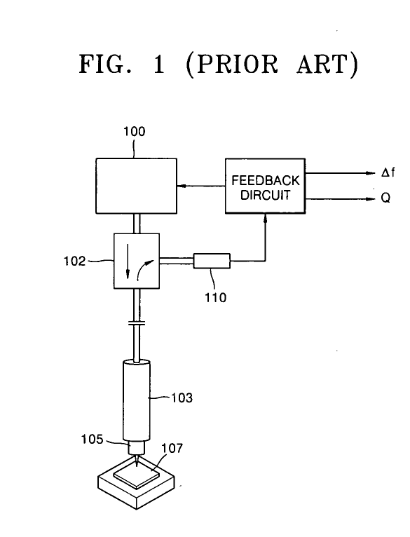

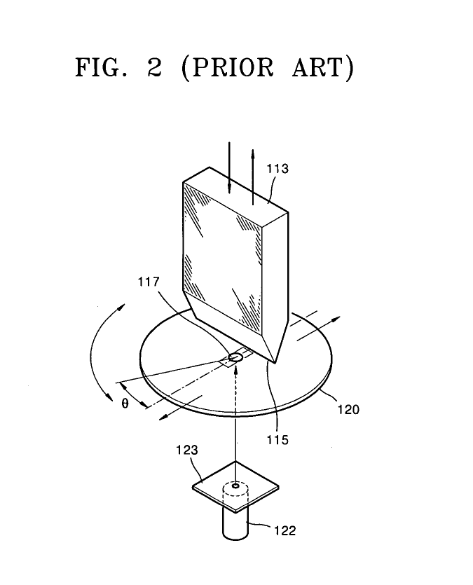

### DETAILED DESCRIPTION OF THE INVENTION

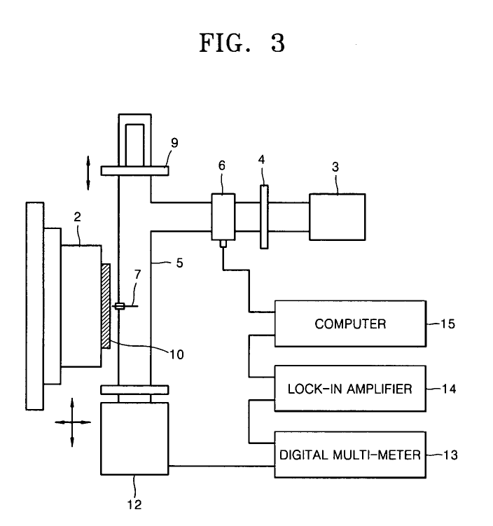

Referring to FIG. 3, a near field microscope according to an embodiment of the present invention includes a wave source 3, a waveguide resonator 5 through which a wave emitted from the wave source 3 is transmitted, and a probe 7, which perforates and inserted into the waveguide resonator 5. A tuner 9 is placed at one side of the waveguide resonator 5 and is movable in a lengthwise direction along the waveguide resonator 5 so as to vary the volume of the waveguide resonator 5.

The wave source 3 produces microwaves and millimeter-waves.

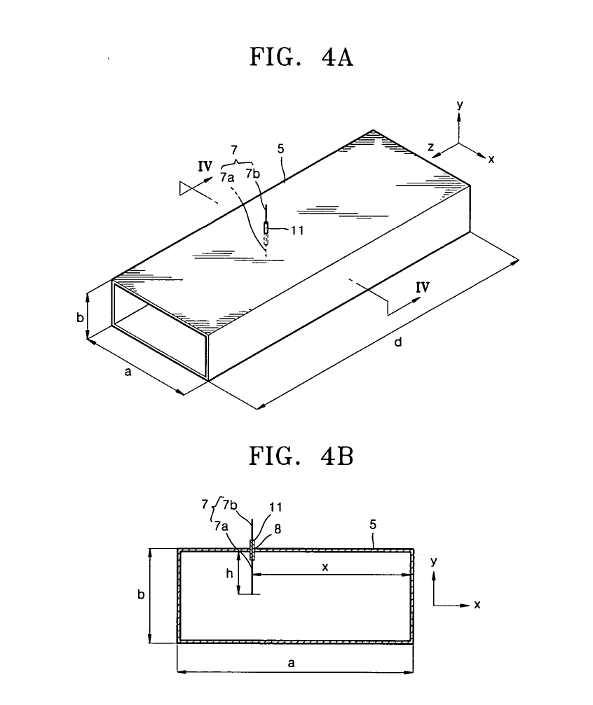

The waveguide resonator 5 has a hallow, and a cross-section of the hollow is formed of one conductor having a rectangular shape, as shown in FIG. 4A. There are only a TM mode and a TE mode and no TEM mode in the above structure formed of one conductor.

Assuming that the cross-sectional width and height of the waveguide resonator 5 are a and b, respectively, the TE mode according to a and b is given by Equation 1. In the TE mode, a z-component of an electrical field satisfies Ez=0, and a z-component Hz of a magnetic field is given by Equation 1.

$$H z ( x , y , z ) = {A}_{mn} cos \frac{m π x}{a} cos \frac{n π y}{b} - {ⅇ}^{- j β z} \qquad ( 1 )$$

Here, z is a coordinate in an advancing direction of a wave, x and y are coordinates perpendicular to z, and n and m are integers. Aₘₙ is the amplitude of the wave that flows through the waveguide resonator 5 when the probe 7 is not inserted into the waveguide resonator 5, and β is a propagation constant.

Next, in the TM mode, a z-direction component of a magnetic field satisfies Hz=0, and Ez is given by Equation 2.

$$Ez ( x , y , z ) = {A}_{mn} sin \frac{m π x}{a} sin \frac{n π y}{b} - {ⅇ}^{- j β z} \qquad ( 2 )$$

Frequency bands of the wave source 3 ranging from 1 GHz to 220 GHz can be used according to the width a and height b of the cross-section of the waveguide resonator 5. In other words, the cut-off frequency of the waveguide resonator 5 is determined according to a and b, and a frequency less than the cut-off frequency cannot propagate through the waveguide resonator 5. A cut-off frequency f_{cmn} of the waveguide resonator 5 is same for both the TE and TM modes and is given by Equation 3.

$${f}_{c mn} = \frac{{k}_{c}}{2 π \sqrt{μ ϵ}} = \frac{1}{2 π \sqrt{μ ϵ}} \sqrt{{( \frac{m π}{a} )}^{2} + {( \frac{n π}{b} )}^{2}} \qquad ( 3 )$$

Here, f_{cmn} is a cut-off frequency of each mode according to a combination of m and n, and it is assumed that the waveguide resonator 5 is filled with a material with a dielectric constant ε and a permeability μ. According to Equation 3, the cut-off frequency is determined by the cross-sectional dimension of the waveguide resonator 5. A mode having the lowest cut-off frequency is a dominant mode. Assuming that a>b, the cut-off frequency is lowest in a TE₁₀ mode. Since a wave with a lower frequency than the cut-off frequency cannot progress through the waveguide resonator 5, as the cut-off frequency decreases, the usable frequency band of the wave extends.

Since the waveguide resonator 5 is used, instead of a coaxial cable resonator in which only the TEM wave is generated, both TE and TM modes are generated such that the region of a sample measured using a larger variety of modes can be enlarged. In addition, unlike a stripline in which only a specific frequency is generated, all frequency bands with frequencies greater than the cut-off frequency can be used. In other words, the width and length of a stripline is determined and manufactured so that only a specific frequency propagates. Thus, the loss of a wave with a frequency other than the specific frequency is very large, and even though the wave propagates, it rapidly dissipates. On the other hand, in the waveguide resonators, a wave with a frequency less than the cut-off frequency is dissipated, and a wave with a frequency greater than the cut-off frequency passes.

As described above, the wave source 3 can perform frequency modulation, and both millimeter-waves and microwaves are used in the waveguide resonator 5. Thus, the wave source 3 performs frequency modulation and produces waves with an appropriate frequency.

Meanwhile, as shown in FIG. 4B, the waveguide resonator 5 has a hole 8. The probe 7 is inserted into the hole 8, and the hole 8 is sealed using Teflon 11 so as to fix the probe 7 in place. The probe 7 is not completely inserted into the waveguide resonator 5, with a portion 7a of the probe 7 inserted into the waveguide resonator 5, and a portion 7b of the probe 7 outside of the waveguide resonator 5.

Referring to FIG. 3, a sample 10, whose optical characteristics are to be measured, is placed adjacent to the portion 7b of the probe 7 outside of the waveguide resonator 5. The sample 10 is put on a movable support 2. As the movable support 2 moves, the sample 10 is scanned.

The probe 7 may be formed of metal, a dielectric material, or a magnetic substance. The probe 7 affects the resolving power of a microscope, is electrochemically etched using a KOH solution, and is manufactured so that an end of the probe 7 has a diameter less than 10 μm. As the diameter of the end of the probe 7 decreases, the resolving power of the microscope is improved. In addition, in order to improve sensitivity as well as resolving power, as shown in FIG. 4C, a hybrid probe 7′ manufactured using partial two-step etching may be used.

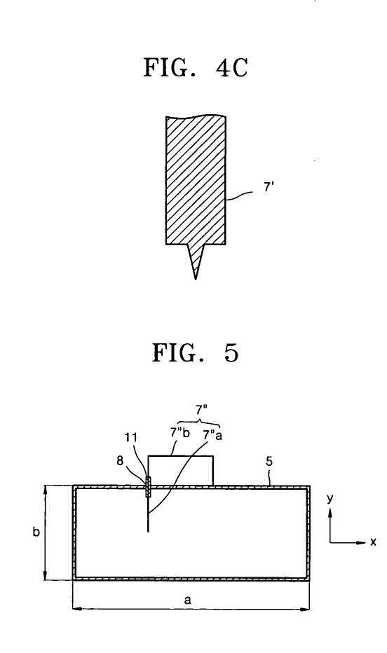

As shown in FIG. 4B, the portion 7a of the probe inside the waveguide resonator 5 has a linear shape and the portion 7b outside the waveguide resonator 5 has a linear shape. Alternatively, as shown in FIG. 5, the probe 7 may be a magnetic probe 7′ comprising a portion 7′a with a linear shape inside the waveguide resonator 5 and a portion 7′b with a loop shape outside the waveguide resonator 5. The electric probe has an impedance larger than the magnetic probe, and thus, is appropriate for measurement of characteristics of a sample having a relatively large impedance. The magnetic probe has impedance smaller than the electric probe, and thus, is appropriate for measurement of the characteristics of a sample having a relatively small impedance.

Next, a current flowing through the probe 7 will be described. Referring to FIG. 4B, if x measures a widthwise position of the waveguide resonator 5 of the probe 7 and h measures a position of the probe portion 7a inside the waveguide resonator 5 in a y-direction, a current value I and a current density J propagating through the probe 7 are given by Equation 4. In this case, the probe 7 is disposed in a y-direction. Thus, the current density J flowing through the probe 7 has only a y-component.

$$\begin{matrix}I ( y ) = {I}_{0} sin [ \frac{ω}{c} ( h - y ) ] \\ \vec{J} = {I}_{0} sin [ \frac{ω}{c} ( h - y ) ] δ ( z ) δ ( x - X ) \hat{y}\end{matrix} \qquad ( 4 )$$

In Equation 4, I₀ is a maximum current propagating through the probe 7, ω=2πf, and c is the speed of light. In addition, the amplitude A_{y} of a wave propagating through the probe 7 is given by Equation 5.

$${A}_{y} = - 2 π \frac{{Z}_{λ}}{c} \int \vec{J} \cdot E {\vec{d}}^{3} x \qquad ( 5 )$$

Here, Z_{λ} is a wave impedance in the waveguide resonator 5. When the probe 7 is inserted into the waveguide resonator 5, only the y-component of the wave remains in both the TE and TM modes. Thus, a y-component of the electric field is given by Equation 6.

$$\begin{matrix}TM mod e \text{:} {E}_{ymn} = \frac{2 π n}{{γ}_{mn} {}^{b} \sqrt{ab}} sin ( \frac{m π x}{a} ) cos ( \frac{n π y}{b} ) \\ TE mod e \text{:} {E}_{umn} = \frac{2 π m}{{γ}_{mn} {}^{a} \sqrt{ab}} sin ( \frac{m π x}{a} ) cos ( \frac{n π y}{b} )\end{matrix} \qquad ( 6 )$$

In Equation 6,

$${γ}_{mn}^{2} = ( \frac{{m}^{2}}{{a}^{2}} + \frac{{n}^{2}}{{b}^{2}} ) .$$

Respective amplitudes A_{TM} and A_{TE} of the TM and TE modes propagating through the probe 7 using Equation 6 are given by Equation 7.

$$\begin{matrix}TM mod e \text{:} {A}_{TM} = \frac{4 {π}^{2} {Z}_{λ} {I}_{0}}{c {γ}_{mn} \sqrt{ab}} sin ( \frac{m π x}{a} ) \frac{cos \frac{ϖ}{c} h - cos \frac{n π}{b} h}{{( n \frac{π}{b} )}^{2} - {( \frac{ϖ}{c} )}^{2}} \frac{n}{b} \\ TM mod e \text{:} {A}_{TE} = \frac{4 {π}^{2} {Z}_{λ} {I}_{0}}{c {λ}_{mn} \sqrt{ab}} sin ( \frac{m π x}{a} ) \frac{cos \frac{ϖ}{c} h - cos \frac{n π}{b} h}{{( n \frac{π}{b} )}^{2} - {( \frac{ϖ}{c} )}^{2}} \frac{m}{a}\end{matrix} \qquad ( 7 )$$

A frequency f₁ of an electromagnetic wave propagating through the probe 7 is given by Equation 8.

$${f}_{1} = \frac{- {Z}_{1} {I}_{0}}{a} \qquad ( 8 )$$

Here, Z₁=k₀η₀/β₁ is a wave impedance of the TE₁₀ mode. k₀ is a depth to which the probe 7 is inserted into the waveguide resonator 5, η₀ is a characteristic impedance of a medium inside the waveguide resonator 5, for example, 377Ω, and β₁ is a propagation constant. In addition, I₀ is an input current flowing though the probe 7 along the waveguide resonator 5. Here, an input resistance Rₘ to the input current flowing through the probe 7 is given by Equation 9.

$${R}_{m} = \frac{2 P}{{I}_{0}^{2}} = \frac{{bZ}_{1}}{a} \qquad ( 9 )$$

Considering Z₁ in Equation 9, if the probe 7 is close to a sample having an electrical resistance, that is, a near field region, an electrical capacitance exists between the probe 7 and the sample 10. The capacitance serves to reduce an input resistance input into the sample 10, and there are a variety of variations in an input resistance to different samples. Based on this principle, a variation in an resistance occurring when the sample 10 is closed into the near field region is measured such that a sample can be imaged.

Because of a near field effect, the sample 10 interacts with the probe 7 in the TE₁₀ mode so that the input resistance to the probe 7 varies according to Equation 9 and the amplitude of the TE,₀ mode varies according to Equation 7. This can be explained by material perturbation theory applied to a waveguide resonator having a rectangular cross-section.

In addition, a wave is transferred to the sample 10 from the probe 7, and a resonance frequency varies by interactions between the wave and the sample 10. In other words, if the probe 7 is close to the sample 10, a new resonator including the sample 10 is formed, and the resonance frequency of the new resonator varies according to physical characteristics of the sample 10. Accordingly, the resonance frequency varied by the interaction between the wave and the sample 10 is measured so that the characteristics of the sample 10 can be measured.

In this way, in the near field microscope according to the present invention, a near field image having high sensitivity and high resolving power can be obtained by electrical interaction between the probe 7 and the sample 10.

Meanwhile, based on shape perturbation theory of electromagnetic distribution, the variation in resonance frequency of the waveguide resonator 5 can be given by Equation 10.

$$\frac{f - {f}_{0}}{{f}_{0}} = \frac{{\int }_{v0} ( μ {\vert {H}_{0} \vert}^{2} - ϵ {\vert {E}_{0} \vert}^{2} ) ⅆ v}{{\int }_{v0} ( μ {\vert {H}_{0} \vert}^{2} + ϵ {\vert {E}_{0} \vert}^{2} ⅆ v} \qquad ( 10 )$$

Here, E₀ and H₀ are an unperturbed electrical field and magnetic field, and ε and μ are dielectric constant and magnetic susceptibility in an unperturbed state, v₀ is the volume of a region in which the electromagnetic field is formed, f is a varied resonance frequency, and f₀ is a resonance frequency before variation. However, when the thickness of the probe 7 is very small, it can be assumed that an electronic field in the waveguide resonator 5 is uniform. On this assumption, when using Equation 10, the hole 8 having a radius of r₀ in positions of a/2, b/2, and d/2 of the waveguide resonator 5 is formed and the probe 7 is installed in the hole 8, Equation 11 is obtained.

$$\frac{f - {f}_{0}}{{f}_{0}} = - \frac{2 d π {r}_{0}}{abd} = - \frac{2 Δ v}{{v}_{0}} \qquad ( 11 )$$

Here, Δ v is a change in volume of the probe 7 with respect to the waveguide resonator 5, and v₀ is the volume of the waveguide resonator 5 when the waveguide resonator is not perturbed. According to Equation 11, as the probe 7 is inserted into the waveguide resonator 5 to a larger depth, the resonance frequency of the waveguide resonator 5 is reduced. The variation in the resonance frequency of the waveguide resonator 5 is measured and Equation 11 is used to determine the depth to which the probe 7 is inserted into the waveguide resonator 5. The depth to which the probe 7 is inserted into the waveguide resonator 5 is adjusted to adjust the resonance frequency of the waveguide resonator 5. Since the resonance frequency of the waveguide resonator 5 can be adjusted using a variety of methods, the range of the resonance frequency of the waveguide resonator 5 is enlarged.

In order to insert the probe 7 into the waveguide resonator 5 in the TE₁₀ mode, the hole 8 is formed in the waveguide resonator 5, the electronic field is polarized through the hole 8, and electrical polarizability αₑ is given by Equation 12.

$${a}_{e} = \frac{3}{2} {r}_{0}^{3} \qquad ( 12 )$$

Here, r₀ is a radius of the hole 8 and electrical polarizability is proportional to the radius of the hole 8 cubed. Thus, if the radius of the hole increases, the strength of a polarization current flowing through hole increases. Accordingly, it is preferable that the hole 8 has the smallest possible radius, and, in order to prevent polarization, the hole 8 is sealed using the Teflon 11.

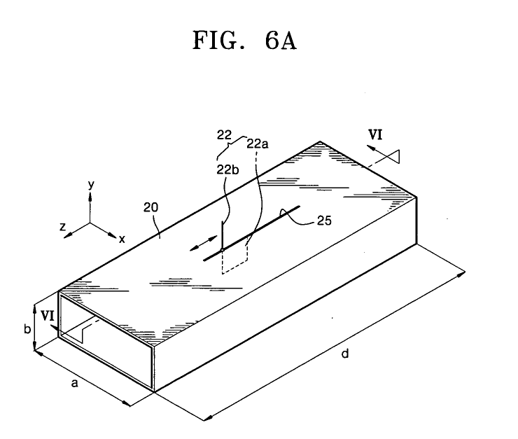

Next, referring to FIG. 6A, in the near field microscope according to a second embodiment of the present invention, a probe 22 is inserted into a waveguide resonator 20, and a probe portion 22a inside the waveguide resonator 20 has a loop shape. In the near field microscope according to the second embodiment of the present invention, only the structure of the waveguide resonator 20 and the probe 22 is different from that of the near field microscope according to the first embodiment of the present invention. Accordingly, the structure of the near field microscope of FIG. 3 may be also applied to the near field microscope according to the second embodiment of the present invention.

According to Faraday's law, an electromotive force is generated in the probe 22 by varying a magnetic field Hx component that passes through the probe portion 22a having the loop shape. The magnetic field should pass vertically through the probe portion 22a having the loop shape so that a maximum electromotive force is generated in the probe portion 22a having the loop shape. Since the magnetic field is perpendicular to the advancing direction of the wave. It is preferable that the probe portion 22a is disposed parallel to the advancing direction of the wave so that the maximum electromotive force is generated in the probe portion 22a. A position at which the maximum electromotive force V is generated in the probe portion 22a having the loop shape can be obtained from Equation 13.

$$V = - \frac{μ j \overline{ω} a y {H}_{0}}{π} [ 2 cos \frac{1}{2} \{ - \frac{p π}{d} ( {z}_{f} + {z}_{i} ) \} sin \frac{1}{2} \{ - \frac{p π}{d} ( {z}_{f} - {z}_{i} ) \} ] \qquad ( 13 )$$

In Equation 13, H₀ is a maximum value of a magnetic field passing through the loop probe portion 22a, and p is a p-value in a TE_{10P} mode. In addition, referring to FIG. 6B, zᵢ is the position of a front end of the loop probe portion 22a, z_{f} is the position of a rear end of the probe portion 22a, and d is the length of the waveguide resonator 20. According to Equation 13, when the loop probe portion 22a is placed in a position that satisfies z_{f}=3d/2p, zᵢ=d/2p, a maximum current is generated in the probe 22. In this case, maximum sensitivity is obtained. For example, when p is 2, the position of the loop probe portion 22a at which the maximum electromotive force is generated satisfies z_{f}=3d/4, zᵢ=d/4. In addition, when the front end position zᵢ of the loop probe portion 22a and the rear end position z_{f} of the loop probe portion 22a are changed, the area of the loop probe portion 22a varies.

As described above, sensitivity varies according to the position at which the probe 22 is inserted into the waveguide resonator 20. Thus, it is preferable that the position of the probe 22 can be adjusted. To this end, as shown in FIG. 6A, a slit 25 is formed in the waveguide resonator 20, and the probe 22 is inserted into the slit 25. The probe 22 can move along the slit 25, thereby adjusting the position of the probe 22. In this way, the probe 22 can be easily adjusted to the position at which the maximum electromotive force is generated in the probe 22. In other words, when there are several modes, the position at which the maximum electromotive force is generated may be varied according to a p-value in the TE_{10P} mode and may be affected by the environment (temperature and humidity etc.). Thus, the position at which the maximum electromotive force is generated may vary. The position at which the maximum electromotive force is generated is searched, for by moving the probe 22 along the slit 25 so that characteristics of a sample can be measured in a variety of modes using one waveguide resonator 20.

Furthermore, the area of the loop probe portion 22a is adjusted so that maximum sensitivity is obtained. As the area of the loop probe portion 22a is increased, a magnetic flux that passes through the loop is increased, and the electromotive force is increased. Several TE modes are generated in the waveguide resonator 20 and the area of the loop probe portion 22a is adjusted so that maximum sensitivity is obtained. Thus, diverse physical characteristics of the sample are imaged differently according to a variety of modes.

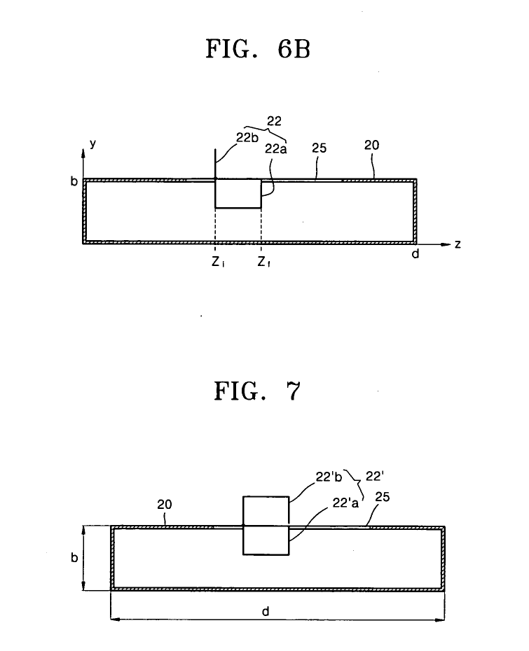

As shown in FIG. 6B, the probe 22 may be an electric probe with a portion 22b outside the waveguide resonator 20 that has a linear shape. Alternatively, as shown in FIG. 7, the probe 22 may be a magnetic probe 22′ whose probe portion 22′b outside the waveguide resonator 20 is a loop. In this case, the probe portion 22′a inside the waveguide resonator 20 is also a loop.

Meanwhile, the input resistance to a current flowing through a probe varies according to the type of a material used for the probes 22 and 22′, and thus, the characteristics of a sample are diverse in each mode. For example, the input resistance varies according to whether a material used for the probe is a magnetic substance, a dielectric material, or a conductor. For example, it is preferable that a metallic probe is formed of steel having a good conductivity.

A method of measuring optical characteristics of a sample using the near field microscope according to the first embodiment of the present invention will now be described. This description may be also applied to the near field microscope according to the second embodiment of the present invention.

Referring to FIG. 3, a wave emitted from the wave source 3 is transmitted through the waveguide resonator 5 via an isolator 4. The wave is transmitted to the sample 10 through the probe 7, and input resistance and resonance frequency varies due to interactions between the wave and the sample 10. Variations in the input resistance and of resonance frequency is measured so that the characteristics of the sample can be measured.

In order to obtain a three-dimensional image of the sample 10, the sample 10 is put on the support 2 that can be driven by a computer (not shown) having a resolving power of 100 nm. The support 2 is connected to the computer via an interface and is automatically adjusted. The support 2 is moved, and the sample 10 is scanned under the probe 7 so that the three-dimensional image of the sample is obtained.

The variation in resonance frequency in microwave and millimeter-wave regions caused by an interaction between the probe 7 and the sample 10 is detected by a diode detector 12. A signal that is modulated by (a few) KHz by a digital multi-meter 13 is amplified by a lock-in amplifier 14. The lock-in amplifier 14 minimizes noise by improving a signal-to-noise ratio in the wave source 3 and the waveguide resonator 5. The amplified signal is processed by a computer 15 and the sample 10 is imaged.

Meanwhile, the input resistance between the wave source 3 and the waveguide resonator 5 can be modulated using a pin diode modulator 6.

Furthermore, in order to increase the degree of combination of an electronic field excited by the waveguide resonator 4, the length of the waveguide resonator 5 is adjusted using the tuner 9. In particular, when the wavelength of the wave emitted from the wave source 3 is λ, it is preferable that the length of the waveguide resonator 5 is adjusted by λ/4. This is because a normal wave is generated in the waveguide resonator 5 and resonance occurs. When the normal wave is generated in the waveguide resonator 5 by adjusting the length of the waveguide resonator 5, maximum reinforced interference occurs, and thus, maximum energy is generated.

As described above, in the near field microscope according to the present invention, an electric probe or a magnetic probe is inserted into a waveguide resonator so that optical characteristics of a sample are measured with a high resolution and high sensitivity.

Furthermore, a variation in input resistance and resonance frequency is measured by an interaction between a wave transferred through the probe inserted into the waveguide resonator and the sample so that the optical characteristics of the sample can be measured. In this way, a near field image from a microwave band to a millimeter-wave band is obtained using the probe inserted into the waveguide resonator, and resolving power is improved. In addition, by using the waveguide resonator and the probe, the volume of the near field microscope is minimized, and electromagnetic properties of the sample are studied using TE and TM waves. In addition, the depth to which the probe is inserted into the waveguide resonator varies, thereby adjusting a resonance frequency, and increasing the range of an operating frequency and the number of applicable fields for the microscope.

In addition, a portion of the probe inserted into the waveguide resonator has a loop shape so that maximum sensitivity is obtained according to the area and position of the loop and an optional near field image is obtained for each mode.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A near field microscope comprising:
a wave source, which emits a wave with a variable frequency;
a waveguide resonator through which the wave emitted from the wave source propagates;
a probe, which perforates an outer wall of the waveguide resonator and by which the wave that propagates through the waveguide resonator interacts with a sample; and
a detector, which detects the wave that has interacted with the sample.

2. The near field microscope of claim 1, further comprising a tuner, which is movably connected to one end of the waveguide resonator and adjusts a length of the waveguide resonator.

3. The near field microscope of claim 1, wherein a portion of the probe inside the waveguide resonator has a linear shape.

4. The near field microscope of claim 1, wherein a portion of the probe inside the waveguide resonator has a loop shape.

5. The near field microscope of claim 1, wherein a probe portion outside the waveguide resonator has a linear shape or a loop shape.

6. The near field microscope of claim 1, wherein the probe is formed of metal, a dielectric material, or a magnetic substance.

7. The near field microscope of claim 4, wherein when H₀ is a maximum value of a magnetic field perforating the portion of the probe inside the waveguide resonator, p is a p-value in a TE_{10P} mode, zᵢ is a position of a front end of the portion of the probe inside the waveguide resonator, z_{f} is the position of a rear end of the portion of the probe inside the waveguide resonator and d is a length of the waveguide resonator, a magnitude of an electromotive force generated in the probe is given by:
$$V = - \frac{{μ}_{0} j ω a y {H}_{0}}{π} [ 2 cos \frac{1}{2} \{ \frac{p π}{d} ( {z}_{f} + {z}_{i} ) \} sin \frac{1}{2} \{ \frac{p π}{d} ( {z}_{f} - {z}_{i} ) \} ] .$$

8. The near field microscope of claim 7, wherein the probe is disposed in a position that satisfies z_{f}=3d/2p, zᵢ=d/2p.

9. The near field microscope of claim 5, wherein a slit is formed in the waveguide resonator, and the probe is movable along the slit.

10. The near field microscope of claim 1, wherein when a width of a cross-section of the waveguide resonator is a, a height of the waveguide resonator is b, and m and n are integers, a cut-off frequency f_{cmn} of the waveguide resonator is given by:
$${f}_{cmn} = \frac{1}{2 π \sqrt{μϵ}} \sqrt{{( \frac{m π}{a} )}^{2} + {( \frac{n π}{b} )}^{2}} ,$$
and a wave with a frequency greater than the cut-off frequency is used.

11. The near field microscope of claim 1, wherein, when a resonance frequency and a volume before the probe is inserted into the waveguide resonator are f₀ and v₀, respectively, and a change in volume of the probe after the probe is inserted into the waveguide resonator is Δ v, a change in resonance frequency f of the waveguide resonator is given by:
$$\frac{f - {f}_{0}}{{f}_{0}} = - \frac{2 Δ v}{{v}_{0}} .$$

12. The near field microscope of claim 1, wherein the probe is a hybrid probe manufactured using partial two-step etching.

13. The near field microscope of claim 1, further comprising a lock-in amplifier, which minimizes noise by improving a signal-to-noise ratio between the wave source and the waveguide resonator.

14. The near field microscope of claim 1, wherein the wave source emits microwaves or millimeter-waves.

15. The near field microscope of claim 1, wherein when a wavelength of the wave emitted from the wave source is λ, the length of the waveguide resonator changes by λ/4 increments.

16. The near field microscope of claim 4, wherein the probe portion having the loop shape is disposed parallel to an advancing direction of the wave.
